(19) United States
(12) Patent Application Publication
(10) Pub. No.: US 2020/0039503 A1
(43) Pub. Date: Feb. 6, 2020

(54) VEHICLE AND METHOD OF COORDINATED LASH MANAGEMENT

(71) Applicant: GM Global Technology Operations LLC, Detroit, MI (US)

(72) Inventors: Shaun C. Bowman, Ann Arbor, MI (US); Ryan H. Jones, Ann Arbor, MI (US); Jason R. Ekelmann, Farmington, MI (US); Adam J. Heisel, South Lyon, MI (US)

(73) Assignee: GM Global Technology Operations LLC, Detroit, MI (US)

(21) Appl. No.: 16/052,701

(22) Filed: Aug. 2, 2018

(51) Int. Cl. B60W 20/19; B60W 10/08; B60W 10/06

(52) U.S. Cl. CPC B60W 20/19; B60W 10/08; B60W 10/06; B60W 2710/083; B60W 2720/106; B60W 2710/0666; B60W 2540/10

(57) ABSTRACT

A method of controlling a change in net axle torque on a vehicle comprises receiving a request for a desired net axle torque that is different than a current net axle torque, determining whether a lash zone exists between the current net axle torque and the desired net axle torque, determining a progression of constant rates of change of the front axle torque and a progression of constant rates of change of the rear axle torque that will result in a constant rate of change of the net axle torque from the current net axle torque to the desired net axle torque, and commanding the progression of constant rates of change of the front axle torque and the progression of constant rates of change of the rear axle torque if the lash zone exists between the current net axle torque and the desired net axle torque.

### INTRODUCTION

The disclosure relates to a vehicle and a method of controlling net axle torque on a vehicle.

Vehicle drive trains may experience lash when a vehicle axle responds to a commanded change in torque. Lash may be characterized as a sharp increase in the frequency of angular rotation and associated torque discontinuities at a vehicle axle when commanded torque provided by a prime mover and the wheel torque, or road load torque, change direction from one another such as due to a driver-commanded change in acceleration. Lash may be due to lost motion resulting from clearances between components in the drivetrain. Lash may be experienced by a driver as a delay in response (referred to as a dead zone or dead pedal) and/or an audible clunking and/or jerkiness that may occur as drivetrain components respond to the change in rotational force.

### SUMMARY

A method of controlling net axle torque on a vehicle is disclosed that enables a constant rate of change in net axle torque while reducing or eliminating lash by coordinating axle torques. More specifically, a method of controlling a change in net axle torque on a vehicle comprises receiving, via an electronic controller, a request for a desired net axle torque that is different than a current net axle torque. The vehicle has a first prime mover configured to provide front axle torque to a front axle and a second prime mover configured to provide rear axle torque to a rear axle, the net axle torque being the sum of the front axle torque and the rear axle torque. The method includes determining, via the electronic controller, whether a lash zone exists between the current net axle torque and the desired net axle torque. The lash zone may extend from a predetermined lower lash zone torque limit to a predetermined higher lash zone torque limit. The predetermined lower lash zone torque limit and the predetermined higher lash zone torque limit may be based on measurements of changes in angular frequency of each axle when lash is not controlled. Accordingly, torque control to minimize the effects of lash is of most value when the net axle torque is within the lash zone.

The method further includes determining, via the electronic controller, a progression of constant rates of change of the front axle torque and a progression of constant rates of change of the rear axle torque that will result in a constant rate of change of the net axle torque from the current net axle torque to the desired net axle torque, with each of the progression of constant rates of change of the front axle torque and the progression of constant rates of change of the rear axle torque including a predetermined constant rate of change in the lash zone. The method then includes commanding, via the electronic controller, the progression of constant rates of change of the front axle torque and the progression of constant rates of change of the rear axle torque if the lash zone exists between the current net axle torque and the desired net axle torque.

In an example, the progression of constant rates of change of the front axle torque and the progression of constant rates of change of the rear axle torque each include a pre-lash zone constant rate of change of torque immediately preceding the lash zone and a post-lash zone constant rate of change of torque immediately succeeding the lash zone. The predetermined constant rate of change of torque through the lash zone may be lower than the pre-lash zone constant rate of change of torque and lower than the post-lash zone constant rate of change of torque.

In an example, the front axle torque and the rear axle torque transition through the lash zone at the predetermined constant rate of change of torque separately, without temporal overlap. The front axle torque and the rear axle torque may transition through the lash zone in immediate succession. For example, determining the progression of constant rates of change of the front axle torque and the progression of constant rates of change of the rear axle torque may be based partially on a predetermined torque split of the front axle torque and the rear axle torque at the desired net axle torque. In such an embodiment, the progression of constant rates of change of the front axle torque and the progression of constant rates of change of the rear axle torque may each include a final constant rate of change of torque in a merge zone immediately succeeding transitioning of both of the front axle torque and the rear axle torque through the lash zone, and the net axle torque may be the desired net axle torque at the end of the merge zone. In this manner, the two prime movers are controlled to transition the vehicle to the desired net axle torque in a relatively short period and in a manner without jerkiness.

If passing through the lash zone is not required in order to achieve the desired net axle torque, then instead of the progression of constant rates of change of the front axle torque and of the rear axle torque, the controller may instead command a single constant rate of change of the front axle torque and a single constant rate of change of the rear axle torque from their respective current torques to their torques at a predetermined torque split that achieves the desired net axle torque.

Additionally, the method may be responsive to changes in driver input during the course of carrying out the method. For example, after receiving the request for a desired net axle torque and prior to commanding the progression of constant rates of change of the front axle torque and the progression of constant rates of change of the rear axle torque, the method may include receiving a request for an updated desired net axle torque, determining whether the lash zone is between the current net axle torque and the updated desired net axle torque, and determining an updated progression of constant rates of change of the front axle torque and an updated progression of constant rates of change of the rear axle torque that will result in an updated constant rate of change of the net axle torque from the current net axle torque to the updated desired net axle torque. Each of the updated progression of constant rates of change of the front axle torque and the updated progression of constant rates of change of the rear axle torque may include the predetermined constant rate of change in the lash zone. The method may then include commanding the updated progression of constant rates of change of the front axle torque and the updated progression of constant rates of change of the rear axle torque if the lash zone exists between the current net axle torque and the updated desired net axle torque.

In carrying out the method, certain parameters may be predetermined. For example, an overall time period for the progression of constant rates of change of the front axle torque and the progression of constant rates of change of the rear axle torque may be predetermined, a lower torque limit (predetermined lower lash zone torque limit) and a higher torque limit (predetermined higher lash zone torque limit) of the lash zone may be predetermined, and the method may be conducted so that, at a time half-way through the overall time period, a first of the front axle torque and the rear axle torque completes a transition through the lash zone and a second of the front axle torque and the rear axle torque begins transitioning through the lash zone.

A vehicle is disclosed that comprises a front axle and a rear axle, a first prime mover configured to provide front axle torque to the front axle and no torque to the rear axle, and a second prime mover configured to provide rear axle torque to the rear axle and no torque to the front axle, a net axle torque being the sum of the front axle torque and the rear axle torque. The vehicle includes an electronic controller configured to: (i) receive a request for a desired net axle torque that is different than a current net axle torque; (ii) determine whether a lash zone exists between the current net axle torque and the desired net axle torque; (iii) determine a progression of constant rates of change of the front axle torque and a progression of constant rates of change of the rear axle torque that will result in a constant rate of change of the net axle torque from the current net axle torque to the desired net axle torque, with each of the progression of constant rates of change of the front axle torque and the progression of constant rates of change of the rear axle torque including a predetermined constant rate of change in the lash zone; and (iv) command the progression of constant rates of change of the front axle torque and the progression of constant rates of change of the rear axle torque if the lash zone exists between the current net axle torque and the desired net axle torque.

In a non-limiting example, each of the first prime mover and the second prime mover could be an internal combustion engine, an electric motor, or a mechanical flywheel. In the case of an electric motor, the electric motor could be powered by energy stored in either a battery or a fuel cell. In the case of an internal combustion engine, the internal combustion engine could be powered by fuel. In the case of a mechanical flywheel, the mechanical flywheel could be powered by stored mechanical energy. In one example, both the first prime mover and the second prime mover are electric motors. In another example, one of the first prime mover and the second prime mover is an electric motor and one of the first prime mover and the second prime mover is an internal combustion engine. In another example, at least one of the first prime mover and the second prime mover is an electric motor powered by a fuel cell.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic illustration of a dual axle vehicle.

FIG. 2 is a schematic illustration of a plot of torque on the vertical axis versus time on the horizontal axis for a front axle, a rear axle, and net axle torque of the vehicle of FIG. 1.

FIG. 3 is a flow diagram of a method of controlling a change in net axle torque of the vehicle of FIG. 1 by coordinated lash management.

FIG. 4 is a schematic illustration of another example of a dual axle vehicle controllable according to the method of FIG. 3.

FIG. 5 is a schematic illustration of another example of a dual axle vehicle controllable according to the method of FIG. 3.

FIG. 6 is a schematic illustration of another example of a dual axle vehicle controllable according to the method of FIG. 3.

FIG. 7 is a schematic illustration of another example of a dual axle vehicle controllable according to the method of FIG. 3.

### DETAILED DESCRIPTION

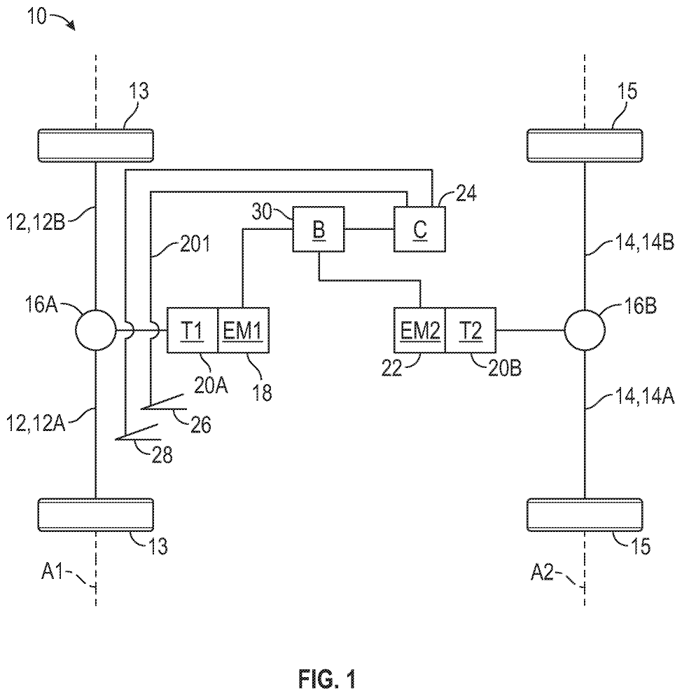

Referring to the drawings, wherein like reference numbers refer to like components throughout the views, FIG. 1 shows a vehicle 10 that may be referred to as a dual axle vehicle. As used herein, a “dual axle vehicle” is a vehicle having two axles that are mechanically disconnected from one another in that they are separately and independently drivable by two different prime movers. For example, as discussed herein, a first prime mover 18 drives a front axle 12 and provides no torque to a rear axle 14, while a second prime mover 22 drives the rear axle 14 and provides no torque to the front axle 12. Net axle torque of the vehicle 10 is the sum of the front axle torque and the rear axle torque.

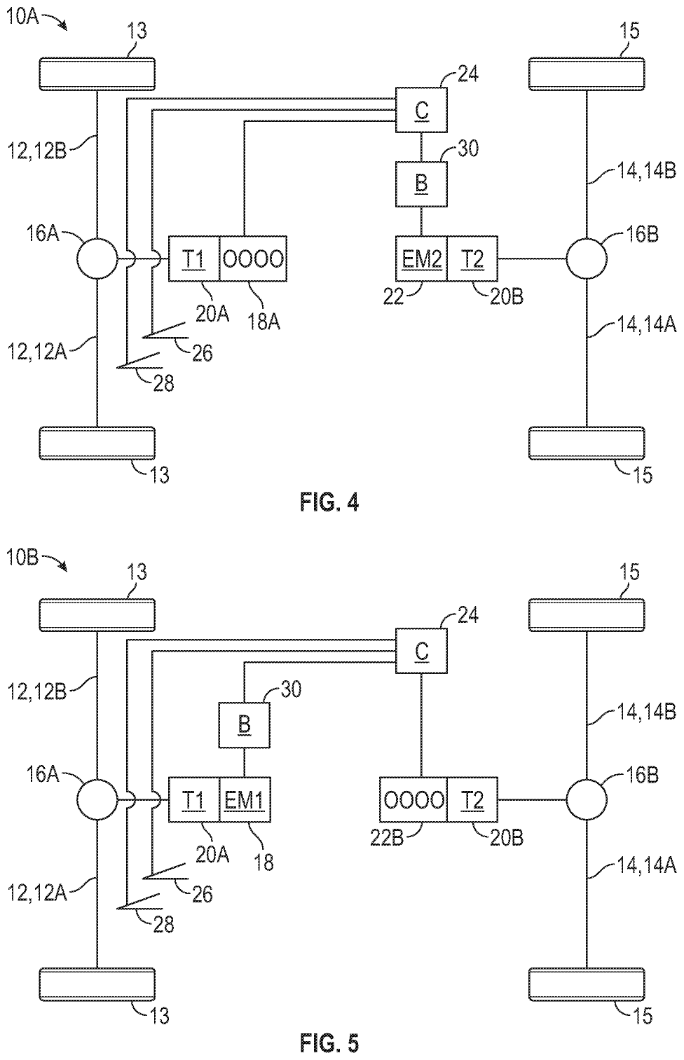

More specifically, the vehicle 10 has a front axle 12 and a rear axle 14. The front axle 12 may include two half shafts 12A, 12B arranged to rotate about a common axis A1, and each connected with a front wheel 13. The half shafts 12A, 12B are connected via a differential 16A through which a first prime mover 18 provides driving torque to the front axle 12. As indicated in FIG. 1, the first prime mover 18 may be operatively connected for driving the front axle 12 through a transmission (T1) 20A that provides a torque ratio from the first prime mover 18 to the front axle 12. In other embodiments, the first prime mover 18 may directly drive the front axle 12 without a transmission 20A. The first prime mover 18 may be one of a number of different types of torque-generating machines such as an electric motor, an internal combustion engine, or a mechanical flywheel. In the embodiment of FIG. 1, the first prime mover 18 is an electric motor EM1. In other embodiments, some of which are shown and described in FIGS. 4-7, the first prime mover is another type of torque-generating machine. The first prime mover 18 does not provide torque to the rear axle 14.

The rear axle 14 may include two half shafts 14A, 14B arranged to rotate about a common axis A2, and each connected with a rear wheel 15. The half shafts 14A, 14B are connected via a differential 16B through which a second prime mover 22 provides driving torque to the rear axle 14. The second prime mover 22 may be operatively connected for driving the rear axle 14 through a transmission (T2) 20B that provides a torque ratio from the second prime mover 22 to the rear axle 14. In other embodiments, the second prime mover 22 may directly drive the rear axle 14 without a transmission 20B. The second prime mover 22 may be one of a number of types of torque-generating machines such as an electric motor, an internal combustion engine, or a mechanical flywheel. In the embodiment of FIG. 1, the second prime mover 22 is an electric motor EM2. The electric motors EM1 and EM2 are traction motors, in that they are controllable to provide tractive torque to the respective axles 12, 14. In other embodiments, some of which are shown and described in FIGS. 4-7, the second prime mover 22 is another type of torque-generating machine. The second prime mover 22 does not provide torque to the front axle 12. Accordingly, the two axles 12, 14 are mechanically disconnected from one another in that they are separately and independently drivable by two different prime movers.

The vehicle 10 includes an electronic controller (C) 24 that is responsive to electronic input signals provided by sensors or other components indicative of various vehicle operating parameters. For example, the input signals may include signals from sensors that sense a position of a braking input device, such as a brake pedal 28, and an accelerator input device, such as an accelerator pedal 26. Based on the input signals and stored instructions, the electronic controller 24 controls the prime movers 18, 22 to provide torque at the respective axles 12, 14. For example, the electronic controller 24 may control an energy storage device such as a battery or a fuel cell that powers the prime mover in the case the prime mover is an electric motor, or the electronic controller 24 may control fuel or stored mechanical energy in the case the prime mover is an internal combustion engine. In FIG. 1, the prime movers 18, 22 are both electric motors, and a battery (B) 30 provides electrical power to the prime movers 18, 22. Although depicted as and discussed as one controller 24, the controller 24 may include multiple separate controllers configured to communicate with one another, and the stored instructions representing the method 200 may be stored on and/or executed on one or more controllers. For example, the vehicle 10 may include separate controllers for each of the prime movers 18, 22, and one or more separate controllers for each of the transmissions 20A, 20B, which controllers may be interconnected to communicate with one another and may be referred to as the controller 24.

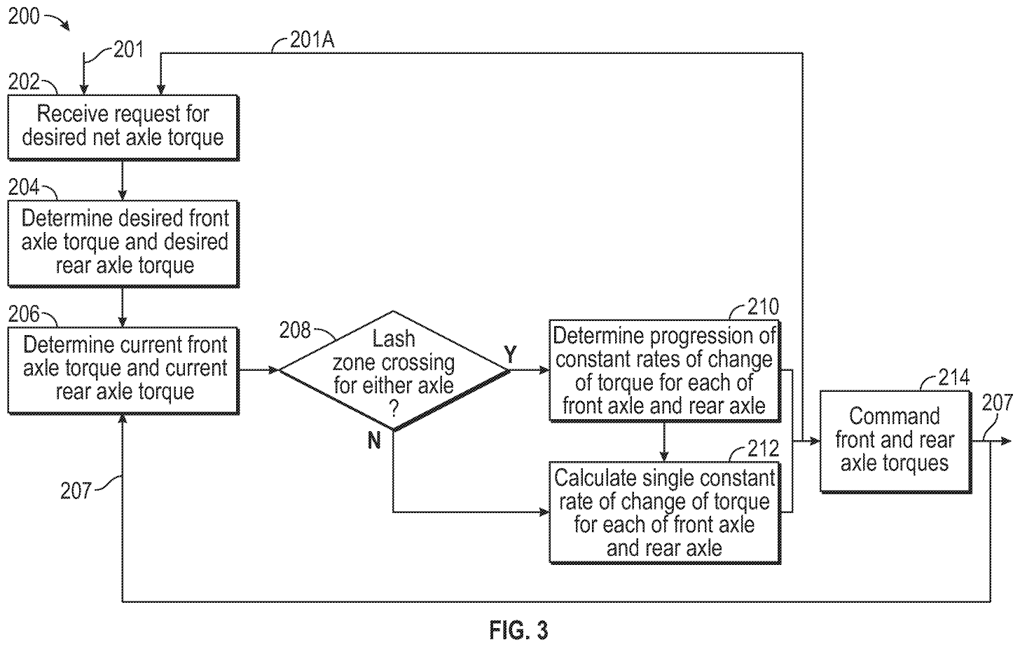

In the embodiments disclosed herein, including the embodiment of FIG. 1, the first prime mover 18 is configured to provide front axle torque to the front axle 12 and no torque to the rear axle 14, and the second prime mover 22 is configured to provide rear axle torque to the rear axle 14 and no torque to the front axle 12. In other words, the prime movers 18, 22 are connected to the respective axles 12, 14 so that the axles 12, 14 are mechanically independent of one another. Such an arrangement allows the controller 24 to control the torque provided at each axle 12, 14 independent of one another. For example, when a driver requests a change in net axle torque, such as by changing a position of the accelerator pedal 26, the controller 24 carries out a method 200 of coordinated lash management to reduce or eliminate displeasing effects (such as abrupt changes in torque or dead zones) that could be associated with either or both axles 12, 14 moving through a predetermined lash zone. The controller 24 is equipped in hardware and programmed in software to execute instructions embodying the method 200, an example of which is referenced as a sequence of steps provided in FIG. 3.

The controller 24 of FIG. 1 may be embodied as a computer device, or multiple such devices, each having one or more processors. The memory includes sufficient amounts of tangible, non-transitory memory, e.g., optical or magnetic read only memory (ROM), erasable electrically-programmable read only memory (EEPROM), flash memory, and the like, as well as transient memory such as random-access memory (RAM). The controller 24 may also include a high-speed clock, analog-to-digital (A/D) circuitry, digital-to-analog (D/A) circuitry, input/output (I/O) circuitry and devices, and signal conditioning/buffering/filtering electronics.

Individual control algorithms resident in the controller 24 or readily accessible thereby, such as instructions embodying the method 200, may be stored in memory and automatically executed via the processor to provide the respective control functionality. Possible control actions resulting from execution of the method 200 are described in detail below. In the flowchart of FIG. 3, “Y” indicates that the controller 24 has determined an affirmative answer to the query of the associated step, and “N” indicates that the controller 24 has determined a negative answer.

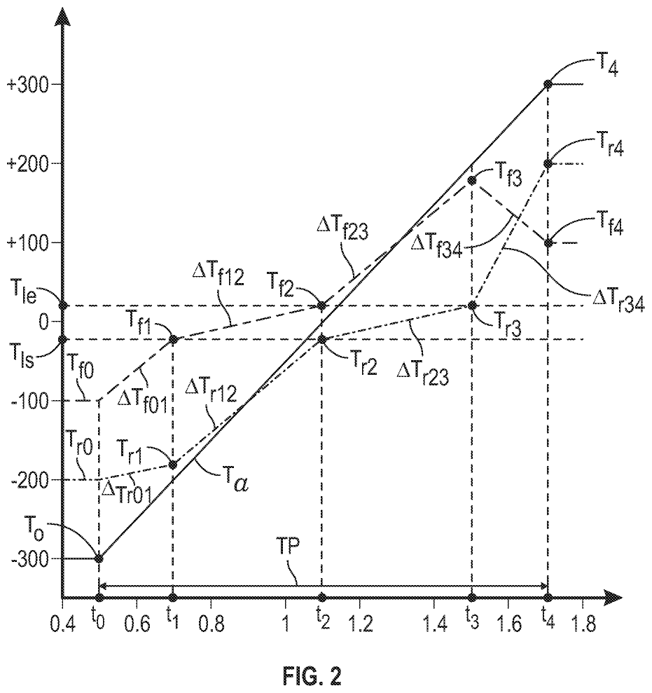

With reference to FIGS. 2 and 3, the method 200 begins at step 202 when, at time to in FIG. 3, the controller 24 receives a request 201 for a desired net axle torque that is different than a current net axle torque. The request 201 may come from a change in position of an accelerator pedal 26 or a change in position of a brake pedal 28, both of which are shown in FIG. 1, movement of a shifter (not shown) in some vehicles, or changes to the settings of a cruise mode. A stored table of magnitudes of net axle torque corresponding with the position of the accelerator pedal 26 or other input mechanism is accessed by the controller 24 to determine the desired net axle torque T₄. In FIG. 2, the desired net axle torque T₄ is indicated as a positive torque with a magnitude of 300 Newton-Meters (N-m), while the current net axle torque T₀ is depicted as a negative axle torque with a magnitude of −300 N-m.

For each magnitude of net axle torque, the controller 24 may have a stored preselected distribution of torque at the front and rear axles 12, 14 to achieve the net axle torque. The stored distribution may be referred to as a preselected torque split, and may be based on one or more engineering parameters that can achieve a desired optimization strategy for the particular vehicle 10. In one non-limiting example, the preselected torque split may be the split of torque that achieves the best efficiencies of the prime movers 18, 22, such as the highest combined motor efficiencies when the prime movers 18, 22 are electric motors, or the highest fuel economy in embodiments when one or both of the prime movers 18, 22 are combustion engines. In commanding front and rear axle torque, whether or not the axles 12, 14 pass through the lash zone (i.e., whether torque is commanded under step 210 or step 212 described herein), the controller 24 commands the stored preselected torque splits at both the current net axle torque (e.g., torque T_{f0} and torque Tᵣ₀) and the desired net axle torque (e.g., torque T_{f4} and torque Tᵣ₄).

In the example of FIG. 2, at the current net axle torque T₀ (i.e., the net axle torque existing when the request for the desired net axle torque is received in step 202), the torque split is current front axle torque T_{f0} at the front axle 12 of −100 Nm, and current rear axle torque Tᵣ₀ at the rear axle 14 of −200 N-m. After the request 201 for desired net axle torque is received in step 202, the controller 24 continues with step 204 and determines the preselected torque split between the front axle 12 and the rear axle 14 that will result in the desired net axle torque T₄. This preselected torque split may be referred to as the desired front axle torque T_{f4} and the desired rear axle torque Tᵣ₄. In the example of FIG. 2, at the desired (i.e., requested) net axle torque T₄ of 300 N-m, the preselected torque split is front axle torque T_{f4} of 100 N-m and rear axle torque Tᵣ₄ of 200 N-m.

Next, in step 206, the controller 24 determines the current front axle torque T_{f0} at the front axle 12, and the current rear axle torque Tᵣ₀ at the rear axle 14. For example, the determination in step 204 may be a calculation based on different sensor signals 207 from sensors on the vehicle 10 that sense vehicle operating parameters and that have magnitudes correlated with the current front and rear axle torques. Generally, the current front and rear axle torques should be equal to the last commanded front and rear axle torques of step 214 as indicated in FIG. 3 and may be determined by accessing stored data reflecting the last commanded front and rear axle torque.

Next, the method 200 proceeds to step 208 in which the controller 24 determines whether either or both of the axles 12, 14 will pass through a predetermined lash zone as the axle torques move from the current front and rear axle torques T_{f0}, Tᵣ₀ to the desired front and rear axle torques T_{f4}, Tᵣ₄. The determination of step 208 is dependent upon whether at least one of the axle torques changes in direction in moving from the current net axle torque to the desired net axle torque. The lash zone may be predetermined as including torque magnitudes of relatively small magnitude and in either direction. In FIG. 2, the lash zone is the area between the dashed horizontal lines. The lash zone thus borders the horizontal axis of magnitude zero torque and extends from a predetermined lower lash zone torque limit Tₗₛ to a predetermined higher lash zone torque limit Tₗₑ of equal magnitude and opposite direction. The values of the lower lash zone torque limit Tₗₛ and the higher lash zone torque limit Tₗₑ correspond to front or rear axle torque values at which the corresponding axle and/or the components in the torque flow between the axle and the corresponding front or rear wheels 13, 15 are in lash while changing torque directions. The values of the lower lash zone torque limit Tₗₛ and the higher lash zone torque limit Tₗₑ may be based upon testing done in a lab, model-based testing, or otherwise.

In the example torque change of FIG. 2, the front and/or rear axle 12, 14 enters the lash zone at the lower lash zone limit Tₗₛ and exits the last zone at the predetermined higher lash zone limit Tₗₑ, and so Tₗₛ may be referred to as a lash start torque and Tₗₑ may be referred to as a lash end torque. Depending on the magnitudes and directions of the current net axle torque T₀ and the desired net axle torque T₄, in other example torque changes, the front and/or rear axle 12, 14 may enter the lash zone at the higher lash zone limit Tₗₑ and exit the lash zone at the lower lash zone limit Tₗₛ.

If the controller 24 determines in step 208 that either of the axles 12, 14 will cross through the lash zone as the net axle torque changes from the current net axle torque T₀ to the desired net axle torque T₄, then the method 200 proceeds from step 208 to step 210. In step 210, the controller 24 determines a progression of constant rates of change of the front axle torque and a progression of constant rates of change of the rear axle torque that will result in a constant rate of change of the net axle torque Tₐ with time from the current net axle torque T₀ to the desired net axle torque T₄. In FIG. 2, the plot of net axle torque Ta is indicated as having a constant rate of change with time from the start time t₀ to the time t₄ when the desired net axle torque T₄ is achieved (i.e., during the time from the current net axle torque T₀ to the desired net axle torque T₄).

In FIG. 2, the progression of constant rates of change of the front axle torque is illustrated by the five different segments of commanded rates of change of different slope (e.g., each segment having a different constant rate of change of torque with time), including a first segment ΔT_{f01} from time t₀ to time t₁, a second segment ΔT_{f12} from time t₁ to time t₂, a third segment ΔT_{f23} from time t₂ to time t₃, a fourth segment ΔT_{f34} from time t₃ to time t₄, and a fifth segment after time t₄ in which torque is held constant at the value T_{f4}. The progression of constant rates of change of the rear axle torque is illustrated by the five different segments of commanded torque of different slope (i.e., different rates of change of torque with time), including a first segment ΔTᵣ₀₁ from time t₀ to time t₁, a second segment ΔTᵣ₁₂ from time t₁ to time t₂, a third segment ΔTᵣ₂₃ from time t₂ to time t₃, a fourth segment ΔTᵣ₃₄ from time t₃ to time t₄, and a fifth segment after time t₄ in which torque is held constant at the value Tᵣ₄.

Each of the progression of constant rates of change of the front axle torque and the progression of constant rates of change of the rear axle torque determined by the controller 24 in step 210 includes a predetermined constant rate of change in the lash zone. Stated differently, the rate of change of front axle torque and the rate of change of rear axle torque in the lash zone as either passes through the lash zone is a constant rate of change of torque per unit of time:

$${k}_{1} \frac{Δ {T}_{l}}{Δ t} ,$$

where k₁ is a constant, T₁ is the torque (N-m) of the axle (front axle 12 or rear axle 14) in the lash zone, and t is time (seconds). Accordingly, the rate of change of front axle torque T_{f12} during the second segment (from time t₁ to time t₂) is the same as the rate of change of rear axle torque Tᵣ₂₃ during the third segment (from time t₂ to time t₃).

The rate of change of the net axle torque Tₐ during the time from the current net axle torque T₀ to the desired net axle torque T₄ is also a constant rate of change of torque per unit of time:

$${k}_{2} \frac{Δ {T}_{a}}{Δ t} ,$$

where k₂ is a constant, Tₐ is the net axle torque (N-m) of front and rear axles 12, 14 in the lash zone, and t is time (seconds). As is evident in FIG. 2 by the slope of the net axle torque Ta per unit of time being greater than the slope of the individual axle torques versus time in the lash zone, the constant rate of change of net axle torque k₂ is greater than the constant rate of change k₁ of torque at each axle in the lash zone. Under the method 200, the axle passing through the lash zone is able to pass through slowly in order to avoid clunk, while the transition to the desired net axle torque is relatively fast. This is achievable by requiring that each axle 12, 14 pass through the lash zone separately under the method 200 without temporal overlap, and in immediate succession in cases where each axle passes through the lash zone. The first axle to pass through the lash zone will be the axle with a current torque closer in magnitude to the lash zone, such as the front axle 12 as represented by T_{f0} at time to in FIG. 2. In FIG. 2, it is evident that the front axle 12 passes through the lash zone from time t₁ to time t₂, and the rear axle 14 passes through the lash zone from time t₂ to time t₃, immediately following the front axle 12. The time period from time t₀ to time t₁ is the time it takes the front axle torque to reach Tₗₛ, and is determined by the combined torques of the front and rear axles 12, 14 that will maintain the constant rate of change k₂ of net axle torque Tₐ. Similarly, the time period from time t₃ to time t₄ is determined by the combined torques of the front and rear axles 12, 14 that will maintain the constant rate of change k₂ of net axle torque Tₐ.

Notably, the front axle torque is reduced from time t₃ to time t₄ while the rear axle torque is increased at a greater rate in order to achieve the desired torque split of T_{f4} and Tᵣ₄ at time t₄. The time period from t₃ to t₄ may be referred to as a merge zone, as the progression of constant rates of change of the front axle torque and the progression of constant rates of change of the rear axle torque each include a final constant rate of change of torque in the merge zone immediately succeeding transitioning of both of the front axle torque and the rear axle torque through the lash zone, and the net axle torque is the desired net axle torque T₄ at the end of the merge zone.

At time t₄, with the desired net axle torque T₄ achieved, the rate of change of torque of both the front axle 12 and the rear axle 14 is commanded to be zero, and the front and rear axle torques are held constant until a subsequent request for a different desired net axle torque.

Based on the rate k₂ and the current and desired net axle torques T₀ and T₄, the overall time period (TP) from the current time to when the controller 24 receives the request 201 for a desired net axle torque T₄ to the time t₄ when the desired net axle torque T₄ is achieved can be determined using the following equation:

k₂=(T₄−T₀)/(t₄−t₀),

where the overall time period TP=t₄−t₀, and therefore:

TP=(T₄−T₀)/k₂.

Under the method 200, the time at which the first axle (e.g., front axle 12) completes passage through the lash zone is the same time at which the second axle (e.g., rear axle 14) begins passage through the lash zone. Under the progression of constant rates of change determined by the controller 24, this is set to occur halfway through the time period TP. As shown in FIG. 2, this occurs at time t₂, where T_{f2} is the torque of the front axle 12 at time t₂, and Tᵣ₂ is the torque of the rear axle at time t₂:

T_{f2}=Tₗₑ, and Tᵣ₂=Tₗₛ.

With the time t₂ determined, the time t₁ and the time t₃ are calculated based on the predetermined constant rate of change k₁ of torque with time for each axle in the lash zone. In order to allow each axle 12, 14 to pass through the lash zone at the relatively low constant rate of change k₁ of torque with time while also maintaining the greater constant rate of change k₂ of net axle torque Tₐ, the axle not passing through the lash zone is provided with torque at a greater constant rate of change with time. Stated differently, the prime mover connected to the axle not passing through the lash zone is controlled to provide an increased constant rate of change of torque.

Accordingly, in FIG. 2, the progression of constant rates of change of the front axle torque and the progression of constant rates of change of the rear axle torque each include a pre-lash zone constant rate of change of torque immediately preceding the lash zone and a post-lash zone constant rate of change of torque immediately succeeding the lash zone. In FIG. 2, the pre-lash zone constant rate of change of torque of the front axle 12 is that of the first segment ΔT_{f01}, and the post-lash zone constant rate of change of torque of the front axle 12 is that of the third segment ΔT_{f23}. The pre-lash zone constant rate of change of torque of the rear axle 14 is that of the second segment ΔTᵣ₁₂, and the post-lash zone constant rate of change of torque of the rear axle is that of the fourth segment ΔTᵣ₃₄. In each case, the predetermined constant rate of change k₁ of torque through the lash zone is lower than the pre-lash zone constant rate of change of torque and lower than the post-lash zone constant rate of change of torque. Stated differently, the constant rate of change of torque of the second segment ΔT_{f12} is less than the pre-lash zone constant rate of change of torque of the first segment ΔT_{f01}, and less than the post-lash zone constant rate of change of torque of the third segment ΔT_{f23}. Similarly, the constant rate of change of torque of the third segment ΔTᵣ₂₃ is less than the pre-lash zone constant rate of change of torque of the second segment ΔTᵣ₁₂, and less than the post-lash zone constant rate of change of torque of the fourth segment ΔTᵣ₃₄. The constant rate of change of torque in the first segment ΔT_{f01} and the constant rate of change of torque in the first segment ΔTr₀₁, as well as the constant rate of change of torque in the fourth segment ΔT_{f34} and the constant rate of change of torque in the fourth segment ΔTᵣ₃₄ are dependent upon the predetermined torque splits at time t₀ and at time t₄, respectively. Accordingly, the progression of constant rates of change of the front axle torque and the progression of constant rates of change of the rear axle torque are based partially on the predetermined torque split of the front axle torque and the rear axle torque at the current net axle torque and at the desired net axle torque.

Following step 210, the method 200 proceeds to step 214 in which the controller 24 commands front and rear axle torques. The command in step 214 will be according to the progression of constant rates of change of the front axle torque and the progression of constant rates of change of the rear axle torque determined in step 210. For example, different constant rates of change of the front axle 12 and the rear axle 14 are commanded at times t₀, t₁, t₂, t₃, and t₄.

However, if it is determined in step 208 that neither of front and rear axles 12, 14 will cross the lash zone in moving from the current torque to the desired net axle torque, then the method 200 moves from step 208 to step 212 instead of to step 210. In step 212, a single constant rate of change of torque per time of the front axle 12 and a different single constant rate of change of torque per unit of time of the rear axle 14 is calculated. For example, if the desired net axle torque received in step 202 is −200 N-m, then a single constant rate of change of torque of the front axle 12 from time t₀ to time t₄ and a single constant rate of change of torque of the rear axle 14 (different than that of the front axle 12) from time t₀ to time t₄ will be calculated in step 212, and then will be commanded in step 214 to be applied until the desired net axle torque of 200 N-m is achieved, which may be in a shorter time period than TP.

The controller 24 is also able to respond to changes in desired net axle torque requested by the driver while the method 200 is running. Stated differently, the driver may request a different desired net axle torque, which may be referred to as an updated desired net axle torque Tₐ, after the original request 201 is received and before step 214, as indicated by updated request 201A. The updated request 201A may be received by the controller 24 prior to the controller 24 commanding the front and rear axle torques in step 214. The controller 24 will return to step 202 of the method 200 and repeat the method 200 as described based on the updated desired net axle torque request 201A. Accordingly, step 208 will include determining whether the lash zone is between the current net axle torque and the updated desired net axle torque. Step 210 will include determining an updated progression of constant rates of change of the front axle torque and an updated progression of constant rates of change of the rear axle torque that will result in an updated constant rate of change of the net axle torque from the current net axle torque to the updated desired net axle torque, and each of the updated progression of constant rates of change of the front axle torque and the updated progression of constant rates of change of the rear axle torque including the predetermined constant rate of change k₁ in the lash zone. Then, in step 214, the controller 24 will command the updated progression of constant rates of change of the front axle torque and the updated progression of constant rates of change of the rear axle torque if the lash zone exists between the current net axle torque and the updated desired net axle torque.

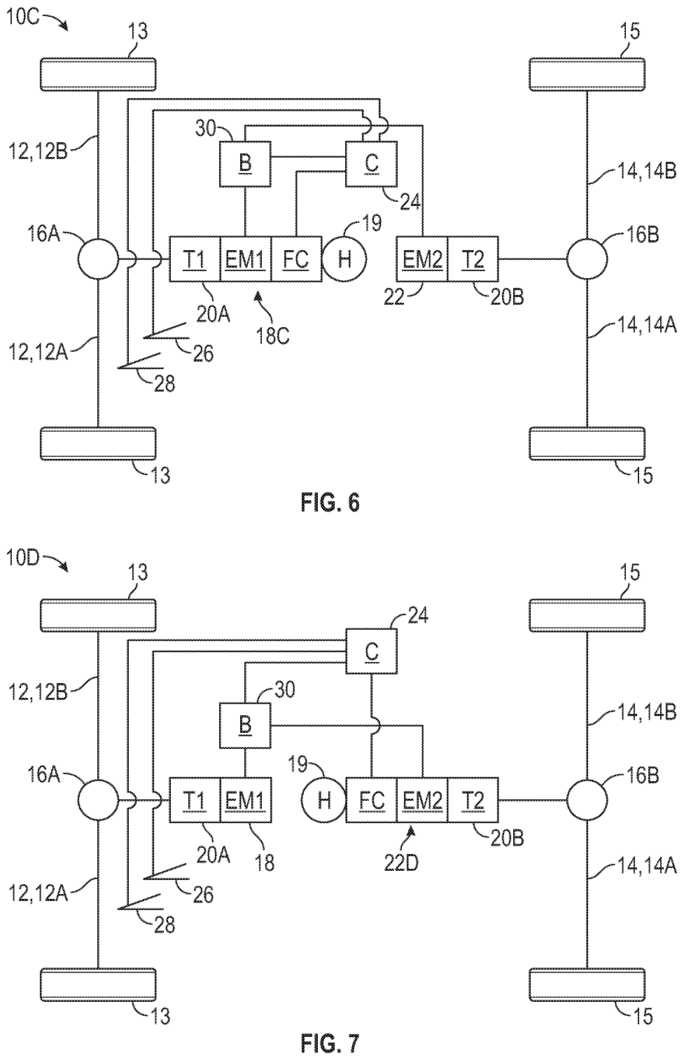

FIGS. 4-7 show a non-limiting set of other embodiments of vehicles for which the method 200 may be carried out as each is a dual axle vehicle that has a first prime mover configured to provide front axle torque to a front axle and no torque to a rear axle, and a second prime mover configured to provide rear axle torque to a rear axle and no torque to the front axle. Like reference numbers in FIGS. 4-7 refer to like components of FIG. 1. Each of FIGS. 4-7 may be considered hybrid vehicles. FIG. 4 shows a vehicle 10A in which the first prime mover 18A is an internal combustion engine and the second prime mover 22 is an electric motor EM2. FIG. 5 shows a vehicle 10B in which the first prime mover 18 is an electric motor EM1 and the second prime mover is an internal combustion engine 22B. FIG. 6 shows a vehicle 10C in which the first prime mover 18C is an electric motor EM1 that is powered by a fuel cell including a hydrogen source 19, a fuel cell stack FC. The second prime mover 22 is an electric motor EM2. FIG. 7 shows a vehicle 10D in which the first prime mover 18 is an electric motor EM1, and the second prime mover 22D is an electric motor EM2 that is powered by a fuel cell including a hydrogen source 19 and a fuel cell stack FC. Each of the vehicles 10A-10D includes the controller 24 configured to carry out the method 200.

Accordingly, the method 200 manages a requested torque change on a dual axle vehicle wherein torque at either or both of the front and rear axles passes through a lash zone, yet enables the net axle torque to change at a constant rate, allows the use of predetermined torque splits between the front and rear axles, allows the axle to have a lower constant rate of change of torque while passing through the lash zone, and is able to adjust to an updated desired net axle torque requested while the method 200 is in the process of responding to an earlier requested desired net axle torque.

While the best modes for carrying out the disclosure have been described in detail, those familiar with the art to which this disclosure relates will recognize various alternative designs and embodiments for practicing the disclosure within the scope of the appended claims.

What is claimed is:

1. A method of controlling a change in net axle torque on a vehicle, the method comprising:
receiving, via an electronic controller, a request for a desired net axle torque that is different than a current net axle torque; wherein the vehicle has a first prime mover configured to provide front axle torque to a front axle and a second prime mover configured to provide rear axle torque to a rear axle; wherein net axle torque is the sum of the front axle torque and the rear axle torque;
determining via the electronic controller, whether a lash zone exists between the current net axle torque and the desired net axle torque;
determining, via the electronic controller, a progression of constant rates of change of the front axle torque and a progression of constant rates of change of the rear axle torque that will result in a constant rate of change of the net axle torque from the current net axle torque to the desired net axle torque, and each of the progression of constant rates of change of the front axle torque and the progression of constant rates of change of the rear axle torque including a predetermined constant rate of change in the lash zone; and
commanding, via the electronic controller, the progression of constant rates of change of the front axle torque and the progression of constant rates of change of the rear axle torque if the lash zone exists between the current net axle torque and the desired net axle torque.

2. The method of claim 1, wherein:
the progression of constant rates of change of the front axle torque and the progression of constant rates of change of the rear axle torque each include a pre-lash zone constant rate of change of torque immediately preceding the lash zone and a post-lash zone constant rate of change of torque immediately succeeding the lash zone; and
the predetermined constant rate of change of torque through the lash zone is lower than the pre-lash zone constant rate of change of torque and lower than the post-lash zone constant rate of change of torque.

3. The method of claim 1, wherein the front axle torque and the rear axle torque transition through the lash zone at the predetermined constant rate of change of torque separately, without temporal overlap.

4. The method of claim 1, wherein the front axle torque and the rear axle torque transition through the lash zone in immediate succession.

5. The method of claim 4, wherein determining the progression of constant rates of change of the front axle torque and the progression of constant rates of change of the rear axle torque is based partially on a predetermined torque split of the front axle torque and the rear axle torque at the desired net axle torque.

6. The method of claim 5, wherein:
the progression of constant rates of change of the front axle torque and the progression of constant rates of change of the rear axle torque each include a final constant rate of change of torque in a merge zone immediately succeeding transitioning of both of the front axle torque and the rear axle torque through the lash zone; and
the net axle torque is the desired net axle torque at the end of the merge zone.

7. The method of claim 1, further comprising:
commanding a single constant rate of change of the front axle torque and a single constant rate of change of the rear axle torque if transitioning through the lash zone is not required.

8. The method of claim 1, wherein the lash zone extends from a predetermined lower lash zone torque limit to a predetermined higher lash zone torque limit.

9. The method of claim 1, further comprising:
after receiving the request for a desired net axle torque and prior to commanding the progression of constant rates of change of the front axle torque and the progression of constant rates of change of the rear axle torque, receiving a request for an updated desired net axle torque;
determining whether the lash zone is between the current net axle torque and the updated desired net axle torque;
determining an updated progression of constant rates of change of the front axle torque and an updated progression of constant rates of change of the rear axle torque that will result in an updated constant rate of change of the net axle torque from the current net axle torque to the updated desired net axle torque, wherein each of the updated progression of constant rates of change of the front axle torque and the updated progression of constant rates of change of the rear axle torque includes the predetermined constant rate of change in the lash zone; and
commanding the updated progression of constant rates of change of the front axle torque and the updated progression of constant rates of change of the rear axle torque if the lash zone exists between the current net axle torque and the updated desired net axle torque.

10. The method of claim 1, wherein:
an overall time period for the progression of constant rates of change of the front axle torque and the progression of constant rates of change of the rear axle torque is predetermined;
a lower torque limit and a higher torque limit of the lash zone are predetermined;
a first of the front axle torque and the rear axle torque completes a transition through the lash zone at a time half-way through the overall time period, and a second of the front axle torque and the rear axle torque begins transitioning through the lash zone at the time half-way through the overall time period.

11. A vehicle comprising:
a front axle and a rear axle;
a first prime mover configured to provide front axle torque to the front axle and no torque to the rear axle;
a second prime mover configured to provide rear axle torque to the rear axle and no torque to the front axle; wherein net axle torque is the sum of the front axle torque and the rear axle torque; and
an electronic controller configured to:
receive a request for a desired net axle torque that is different than a current net axle torque;
determine whether a lash zone exists between the current net axle torque and the desired net axle torque;
determine a progression of constant rates of change of the front axle torque and a progression of constant rates of change of the rear axle torque that will result in a constant rate of change of the net axle torque from the current net axle torque to the desired net axle torque, and each of the progression of constant rates of change of the front axle torque and the progression of constant rates of change of the rear axle torque including a predetermined constant rate of change in the lash zone; and
command the progression of constant rates of change of the front axle torque and the progression of constant rates of change of the rear axle torque if the lash zone exists between the current net axle torque and the desired net axle torque.

12. The vehicle of claim 11, wherein both the first prime mover and the second prime mover are electric motors.

13. The vehicle of claim 11, wherein one of the first prime mover and the second prime mover is an electric motor and one of the first prime mover and the second prime mover is an internal combustion engine.

14. The vehicle of claim 11, wherein at least one of the first prime mover and the second prime mover is an electric motor powered by at least one of a battery or a fuel cell.

15. The vehicle of claim 11, wherein the front axle torque and the rear axle torque transition through the lash zone at the predetermined constant rate of change of torque separately, without temporal overlap.

16. The vehicle of claim 11, wherein the front axle torque and the rear axle torque transition through the lash zone in immediate succession.

17. The vehicle of claim 11, wherein the electronic controller is configured to determine the progression of constant rates of change of the front axle torque and the progression of constant rates of change of the rear axle torque based partially on a predetermined torque split of the front axle torque and the rear axle torque at the desired net axle torque.

18. The vehicle of claim 11, wherein the electronic controller is configured to command a single constant rate of change of the front axle torque and a single constant rate of change of the rear axle torque from the current net axle torque to the desired net axle torque if transitioning through the lash zone is not required.

19. The vehicle of claim 11, wherein if after receiving the request for a desired net axle torque and prior to commanding the progression of constant rates of change of the front axle torque and the progression of constant rates of change of the rear axle torque, the electronic controller receives a request for an updated desired net axle torque, the electronic controller is configured to:
determine whether the lash zone is between the current net axle torque and the updated desired net axle torque;
determine an updated progression of constant rates of change of the front axle torque and an updated progression of constant rates of change of the rear axle torque that will result in an updated constant rate of change of the net axle torque from the current net axle torque to the updated desired net axle torque, wherein each of the updated progression of constant rates of change of the front axle torque and the updated progression of constant rates of change of the rear axle torque includes the predetermined constant rate of change in the lash zone; and
command the updated progression of constant rates of change of the front axle torque and the updated progression of constant rates of change of the rear axle torque if the lash zone exists between the current net axle torque and the updated desired net axle torque.

20. The vehicle of claim 11, wherein:
an overall time period for the progression of constant rates of change of the front axle torque and the progression of constant rates of change of the rear axle torque is predetermined;
a lower torque limit and a higher torque limit of the lash zone are predetermined;
a first of the front axle torque and the rear axle torque completes a transition through the lash zone at a time half-way through the overall time period and a second of the front axle torque and the rear axle torque begins transitioning through the lash zone at the time half-way through the overall time period;
the progression of constant rates of change of the front axle torque and the progression of constant rates of change of the rear axle torque each include a final constant rate of change of torque in a merge zone immediately succeeding transitioning of both of the front axle torque and the rear axle torque through the lash zone; and
the net axle torque is the desired net axle torque at the end of the merge zone.
